(19) United States
(12) Patent Application Publication
(10) Pub. No.: US 2011/0284330 A1
(43) Pub. Date: Nov. 24, 2011

(54) Elevator emergency phone - light combination

(76) Inventor: Samuel Joseph Massameno, Torrington, CT (US)

(21) Appl. No.: 12/800,850

(22) Filed: May 24, 2010

(51) Int. Cl. B66B 3/00

(52) U.S. Cl. 187/391

(57) ABSTRACT

The present invention is a combined emergency communication and illumination system for an elevator car that activates automatically upon the malfunction of the elevator occasioned by a reduction or cessation of AC voltage. The combined system automatically illumines the elevator car with an emergency, high-brightness LED system and initiates an emergency telephone call for assistance to monitoring personnel, who can thereby communicate with any occupant of the elevator car. The combined system is powered by a rechargeable DC battery. The system also enables monitoring personnel to activate a flashing LED in the elevator car that is next to labeling that notifies passengers that help is on the way when such LED flashes on and off.

### CROSS-REFERENCE TO RELATED APPLICATIONS

None

### STATEMENT REGARDING FEDERALLY SPONSORED RESEARCH OR DEVELOPMENT

The invention that is the subject of this specification has not been made under federally sponsored research and development.

### REFERENCE TO SEQUENCE LISTING, TABLE, OR COMPUTER PROGRAM

This specification does not include reliance upon any information contained in a compact disc.

### BACKGROUND OF THE INVENTION

The invention that is the subject of this specification relates generally to apparatuses used by passengers in an elevator car that has malfunctioned to communicate by telephone with monitoring personnel and to secure illumination of the elevator car in the event of a power outage that prevents normal illumination. Under prior art, such communication and illumination would be accomplished through separate, independent emergency systems. The present invention combines those functions and automates them, rendering their operation more reliable, more effective, safer and less costly.

The present invention is more reliable because it reduces the operation of the electronic circuitry and components that are necessary to accomplish the two emergency functions, rendering the system simpler with less duplicative parts.

The present invention is more effective because it requires only one emergency system to respond to an elevator malfunction by providing communication and illumination assistance to the occupants of the elevator car. The unitary system has fewer parts, rendering it less likely to malfunction during an emergency caused by a power outage or elevator malfunction. The combined emergency communication and lighting system also consumes less energy.

The present invention is safer because it includes an automatic triggering system that effectuates a telephone call for assistance upon loss of power without an occupant of the elevator car having to activate the emergency call system by depressing the emergency call button. This feature avoids delay in calling for help that could result from fear, confusion, or disorientation that may arise from momentary darkness and changes in illumination upon activation of the emergency lights, stoppage of the elevator car, and awareness of one's confinement therein. The combined system also notifies the occupants that the emergency call has been effective by establishing oral communication with responding personnel. It also notifies occupants of the elevator car that help is on the way when responding personnel remotely activate the “Help On The Way” light inside the elevator car, thereby assuring the occupants that the elevator's emergency assistance system is functioning and that there is no cause for panic. The combined system also automatically triggers the emergency lighting system upon a power malfunction of the elevator, which automatic triggering is required by current safety codes and is part of current art.

Finally, the combined emergency communication and illumination system is less costly to manufacture and operate than two, independent systems that accomplish the same results.

### BRIEF SUMMARY OF THE INVENTION

The present invention relates to a combined emergency communication and illumination system for an elevator car that activates upon the malfunction of the elevator. It consists of electronic circuitry from a typical 120 volt, alternating current (hereinafter “AC”) source that is connected to a transformer that renders the current 12 volt, AC; and thereafter to a test switch that interrupts power (simulating a power outage), which activates the emergency lighting and triggers an emergency telephone call to monitoring personnel; thereafter, such circuitry is connected to an emergency light printed circuit board (hereinafter “PCB”), which activates light emitting diodes (hereinafter “LEDs”) that are situated in the elevator car in such a way as to provide adequate illumination; said circuitry thereafter connects to a PCB that supports the emergency telephone function, and from which is charged a rechargeable direct current (hereinafter “DC”) battery, which powers both the emergency telephone and illumination systems upon the existence of a malfunction that includes a loss of AC power. The present invention includes an automatic triggering system that effectuates a telephone call for assistance upon loss of AC power without an occupant of the elevator car activating the emergency call system by depressing the emergency call button. In the event of a malfunction that does not include a loss of AC power, no emergency illumination of the elevator or automatic activation of the emergency telephone will occur. The emergency telephone PCB has a double telephone wire that is connected to an active telephone line and is used to make an automatic or manual emergency telephone call to monitoring personnel.

### BRIEF DESCRIPTION OF THE DRAWING

FIG. 1 depicts the circuitry from the 120 volt, alternating current power source, identified by the number 1; which thereafter connects to the step down transformer, identified by the number 2, which produces 12 volt, AC; which thereafter connects to a power test switch, identified by the number 3, which interrupts AC power (simulating a power outage), activating the emergency lighting and triggering an emergency telephone call to monitoring personnel; thereafter, such circuitry is connected to a PCB that converts AC power to DC power and controls the emergency telephone and rechargeable DC battery (hereinafter “Phone-Battery PCB”), identified by the number 4, which PCB is connected by circuitry to the emergency light PCB, identified by the number 5, which monitors for a reduction or cessation of AC voltage that triggers both the emergency lights and an emergency telephone call to monitoring personnel, in which an occupant of the elevator car may engage without doing anything except to respond to the voice of the monitoring personnel as though such personnel were in the elevator car. FIG. 1 also depicts a high brightness LED PCB, identified by the number 6, which is mounted with a lens inside the elevator car, and is activated through circuitry from the emergency light PCB, identified by the number 5. FIG. 1 also depicts circuitry from the emergency light PCB to the Phone-Battery PCB, identified by the number 4, which circuitry triggers an automatic emergency call command upon a reduction or cessation of AC voltage. FIG. 1 also depicts a two-wire telephone line that connects the Phone-Battery PCB to an active public exchange or private monitoring phone line, identified by the number 8; it also depicts circuitry from Phone-Battery PCB to a rechargeable DC battery, identified by the number 7, which powers both the emergency phone and the emergency light. FIG. 1 also depicts circuitry from the Phone-Battery PCB to the microphone, which is identified by the number 9, and speaker, which is identified by the number 10; both of which are mounted to the control panel inside the elevator car and used for emergency two-way telephone communication. FIG. 1 also depicts an emergency call button, identified by the number 11, which is mounted on the control panel and is the mechanism that any elevator passenger can depress to summon help in the event of an emergency. Finally, FIG. 1 depicts an LED, identified by the number 12, which is connected to the Phone-Battery PCB and mounted on the control panel next to a label that notifies passengers that help is on the way when the light is flashing. Monitoring personnel remotely activate such LED after successful completion of the emergency call.

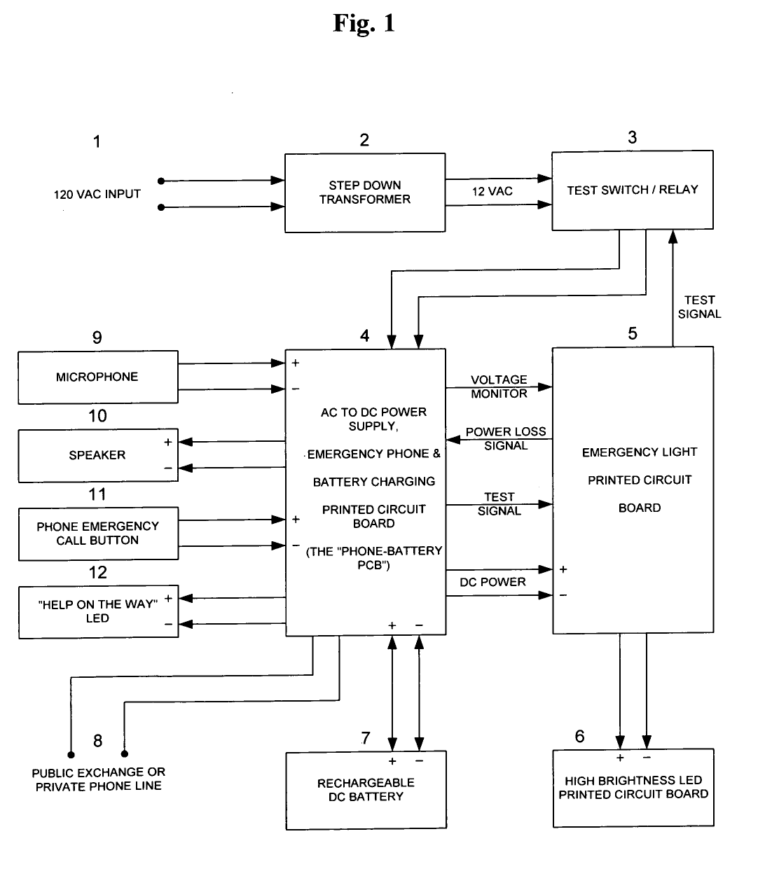

### DETAILED DESCRIPTION OF THE INVENTION

The present invention relates to a combined emergency communication and illumination system for an elevator car that activates upon the malfunction of the elevator. It consists of electronic circuitry from a typical 120 volt, AC source that is connected to a step down transformer that renders the current 12 volt, AC; and thereafter to a power test switch that interrupts power (simulating a power outage), which activates the emergency lighting and triggers an emergency telephone call to monitoring personnel, whether located on-site or at another location; thereafter, such circuitry is connected to an AC to DC power transformer and emergency phone and battery PCB that is connected by circuitry to the emergency light PCB, which monitors for a reduction or cessation of AC voltage that triggers both the emergency lights and an emergency telephone call to monitoring personnel. Upon a reduction or cessation of AC voltage, the emergency light PCB activates LEDs that are situated in the elevator car in such a way as to provide adequate illumination. The circuitry thereafter connects to a PCB (the Phone-Battery PCB) that supports the emergency telephone function, and from which is charged a rechargeable DC battery, which powers both the emergency telephone and illumination systems upon a drop or cessation of AC voltage to the elevator car. The present invention includes an automatic triggering system that effectuates a telephone call for assistance upon a drop or loss of AC power without an occupant of the elevator activating the emergency call system by depressing the emergency call button. In the event of a malfunction that does not include a loss of AC power or of illumination, no emergency illumination of the elevator car or automatic activation of the emergency telephone will occur. The Phone-Battery PCB has a double telephone wire that connects to an active public exchange or private telephone line upon the automatic or manual making of an emergency telephone call to monitoring personnel, who may be located on-site or at another location. The Phone-Battery PCB also connects by circuitry to a microphone and a speaker, mounted in the elevator car, which enable the functions of the emergency telephone so that an occupant of the elevator car can speak with monitoring personnel as though they were present inside the car. The Phone-Battery PCB also connects by circuitry to an emergency push button that is mounted in the elevator car, which manually activates an emergency call for help. The Phone-Battery PCB further connects by circuitry to an LED, which is mounted on the control panel and is activated remotely by monitoring personnel to flash on and off; labeling on the control panel next to this LED notifies passengers that help is on the way when the light is flashing.

We claim:

1. A combined emergency communication and illumination system for an elevator car that activates upon the malfunction of the elevator. It consists of electronic circuitry from a typical 120 volt, AC source that is connected to a step down transformer that renders the current 12 volt, AC; and thereafter to a power test switch that interrupts power (simulating a power outage), which activates the emergency lighting and triggers an emergency telephone call to monitoring personnel, whether located on-site or at another location; thereafter, such circuitry is connected to an AC to DC power transformer and emergency phone and battery PCB that is connected by circuitry to the emergency light PCB, which monitors for a reduction or cessation of AC voltage that triggers both the emergency lights and an emergency telephone call to monitoring personnel. Upon a reduction or cessation of AC voltage, the emergency light PCB activates LEDs that are situated in the elevator car in such a way as to provide adequate illumination. The circuitry thereafter connects to a PCB (the Phone-Battery PCB) that supports the emergency telephone function, and from which is charged a rechargeable DC battery, which powers both the emergency telephone and illumination systems upon a drop or cessation of AC voltage to the elevator car. The present invention includes an automatic triggering system that effectuates a telephone call for assistance upon a drop or loss of AC power without an occupant of the elevator activating the emergency call system by depressing the emergency call button. In the event of a malfunction that does not include a loss of AC power or of illumination, no emergency illumination of the elevator car or automatic activation of the emergency telephone will occur. The Phone-Battery PCB has a double telephone wire that connects to an active public exchange or private telephone line upon the automatic or manual making of an emergency telephone call to monitoring personnel, who may be located on-site or at another location. The Phone-Battery PCB also connects by circuitry to a microphone and a speaker, mounted in the elevator car, which enable the functions of the emergency telephone so that an occupant of the elevator car can speak with monitoring personnel as though they were present inside the car. The Phone-Battery PCB also connects by circuitry to an emergency push button that is mounted in the elevator car, which manually activates an emergency call for help. The Phone-Battery PCB further connects by circuitry to an LED, which is mounted on the control panel and is activated remotely by monitoring personnel to flash on and off; labeling on the control panel next to this LED notifies passengers that help is on the way when the light is flashing.

2. A combined emergency communication and illumination system for an elevator car as described in claim 1 that does not include an automatic triggering system that effectuates a telephone call for assistance upon loss of AC power without an occupant of the elevator activating the emergency call system by depressing the emergency call button.

3. A combined emergency communication and illumination system for an elevator car as described in claim 1 that does not include a switch that tests the functionality of the emergency telephone and illumination systems.

4. A combined emergency communication and illumination system for an elevator car as described in claim 1 that can be tested remotely by use of circuitry and a test relay, instead of a test switch.
